(19) United States
(12) Patent Application Publication
(10) Pub. No.: US 2023/0050736 A1
(43) Pub. Date: Feb. 16, 2023

(54) SOLAR-POWERED LIGHT RAIL TRANSIT SYSTEM

(71) Applicant: MJ Stewart Investments, LLC, Washington, UT (US)

(72) Inventors: Wayne A. Provost, Ivins, UT (US); Jeffrey Stewart, Washington, UT (US); Berkley Wyatt Anderson, Washington, UT (US)

(73) Assignee: MJ Stewart Investments, LLC, Washington, UT (US)

(21) Appl. No.: 17/819,142

(22) Filed: Aug. 11, 2022

Related U.S. Application Data
(60) Provisional application No. 63/232,936, filed on Aug. 13, 2021.

(51) Int. Cl. B60L 8/00; B60L 5/39

(52) U.S. Cl. CPC B60L 8/003; B60L 5/39; B60L 2200/26

(57) ABSTRACT

A light rail transit system has a railcar having a roller coaster wheel assembly, solar panels, a battery bank, an inverter, a solar charge controller, and a power rail contactor. The light rail system further has a rail system having a first riding rail and a second riding rail for receiving the roller coaster wheel assembly, and a power rail for providing backup power to the railcar via the power contactor, the power rail extending less than the length of the first riding rail and second riding rail and only supplying current when the power rail contactor of the railcar is in contact therewith.

### CROSS-REFERENCE TO RELATED APPLICATIONS

This application claims the benefit of U.S. Provisional Application Ser. No. 63/232,936, filed on Aug. 13, 2021, which is incorporated herein by reference.

### TECHNICAL FIELD

The present disclosure relates to rail transit systems. More particularly, the present disclosure relates to an electric railcar primarily powered by a network of solar panels.

### BACKGROUND

With growing populations, there is a constant need for public transportation. As a result, buses, trains, trolleys, and subways (collectively referred to as “vehicles”) have been used. However, most of these public transportation platforms rely on gas or diesel fuel, and output harmful emissions. Others rely on electricity or, more recently, battery power. Electric locomotives and trolleys in the art commonly rely on grid power from a utility provider. However, with recent advents in battery technology, many municipalities are turning to battery power for other modes of transportation, like buses. Whether directly powered by electricity or batteries, the electricity typically comes from power plants which use fossil fuels and create harmful emissions. In an effort to combat this, there have been attempts in the prior art to use renewable energy to power public transportation vehicles. Regardless of whether fossil fuels or renewable energy sources are used, the power must be conveyed to the vehicle. For trolleys and trains, this typically entails a network of overhead powerlines (known as a “catenary”) positioned above the travel path with a pantograph (a type of electric current collector) for electrically coupling the catenary to the trolley or train. In other methods, a contact shoe may extend from the bogie to contact an electric rail (typically referred to as a third rail). However, both the catenary and the contact shoe methods have shortcomings.

For example, overhead wires are unsightly and are highly susceptible to weather (e.g., high winds) and other environmental factors that may cause outages, as well as other vehicles that may accidentally come into contact with the catenary, such as commercial transport trucks, cranes, or other large vehicles. Regarding the third rail system, the biggest shortcoming is that the third rail is live with power where it may easily be contacted by persons or animals, risking electrocution and death. Because of these dangers, the Network Rail and British Transport Police have run campaigns, such as the “You vs. Train” campaign to educate people about the dangers of the third rail. However, people are still regularly come into contact with the third rail and are electrocuted. In addition, whether using a catenary or third rail, both systems are susceptible to interruptions in grid power, leading to a loss in movement.

Accordingly, there is a need for a rail system that utilizes renewable energy, that is not susceptible to grid power loss, that is not unsightly, and that reduces or eliminates risk of electrocution. The present disclosure solves these and other problems.

### SUMMARY OF EXAMPLE EMBODIMENTS

In some embodiments, a light rail transit system comprises a railcar, a first riding rail and a second riding rail, at least one power rail, and a plurality of solar panels for providing power to the at least one power rail. The railcar comprises a plurality of first wheel assemblies on a first side and a plurality of second wheel assemblies on a second side, a plurality of solar panels, a solar charge controller, a battery bank, one or more electric motors for driving the wheel assemblies, an inverter, and at least one power rail contactor.

In some embodiments, the at least one power rail only transmits power when the railcar is in contact with the at least one power rail. In some embodiments, when the railcar is not in contact with the at least one power rail, the one or more electric motors receive power from the battery bank and/or the plurality of solar panels on the railcar to drive the railcar.

### BRIEF DESCRIPTION OF THE DRAWINGS

FIG. 1 illustrates a top, side perspective view of a light rail transit system and station;

FIG. 2 illustrates a top plan view of a light rail transit system and station;

FIG. 3 illustrates a top, right side perspective view of a railcar of a light rail transit system;

FIG. 4 illustrates a bottom, left side detailed perspective view of a railcar of a light rail transit system;

FIG. 5 illustrates a front elevation view of two pair of tracks of a light rail transit system;

FIG. 6 illustrates a bottom, right side perspective view of a light rail transit system;

FIG. 7 illustrates a detailed, left side perspective view of a plurality of power rail contactors contacting a plurality of power rails of a light rail transit system;

FIG. 8 illustrates a detailed, rear perspective view of a plurality of power rail contactors contacting a plurality of power rails of a light rail transit system;

FIG. 9 illustrates a detailed, right side elevation view of one or more power rail contactors before contacting one or more power rails of a light rail transit system;

FIG. 10 illustrates a detailed, right side elevation view of one or more power rail contactors in contact with one or more power rails of a light rail transit system;

FIG. 11 illustrates a detailed, rear elevation view of one or more power rail contactors before contacting one or more power rails of a light rail transit system;

FIG. 12 illustrates a detailed, rear elevation view of one or more power rail contactors in contact with one or more power rails of a light rail transit system.

FIG. 13 illustrates a detailed perspective view of a section of track having a power rail in the center thereof;

FIG. 14 illustrates a detailed perspective view of a section of track having two power rails in the center thereof and controlled via a controller;

FIG. 15 illustrates a detailed perspective view of a section of track having two power rails in the center thereof and controlled via a controller with an infrared sensor;

FIG. 16 illustrates a detailed perspective view of power rail of a light rail transit system;

FIG. 17 illustrates a detailed perspective view of power rail of a light rail transit system;

FIG. 18 illustrates a detailed perspective view of power rail of a light rail transit system;

FIG. 19 illustrates a top plan view of tracks comprising intermittent power rails; and

FIG. 20 illustrates a top plan view of tracks comprising intermittent power rails.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there is a need for a rail transit system that utilizes renewable energy, that is not susceptible to grid power loss, that is not unsightly, and that reduces or eliminates risk of electrocution. The light rail transit system disclosed herein solves these and other problems.

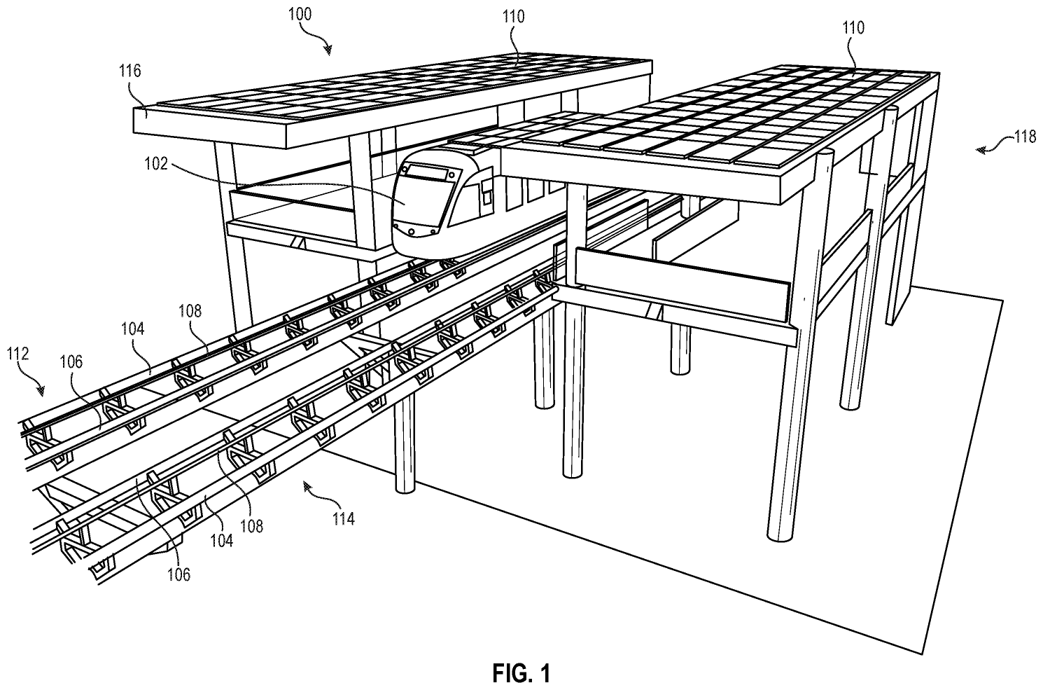

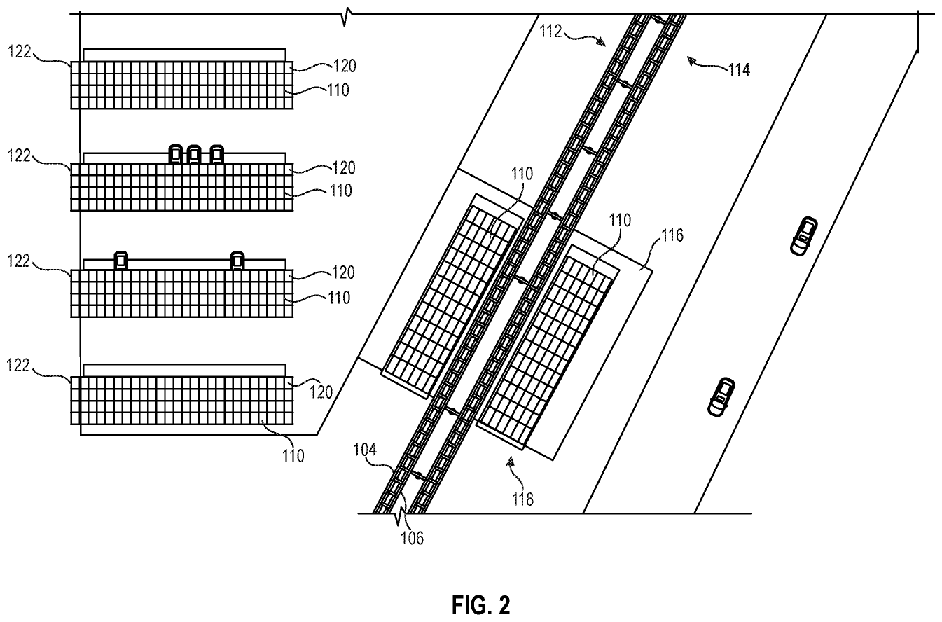

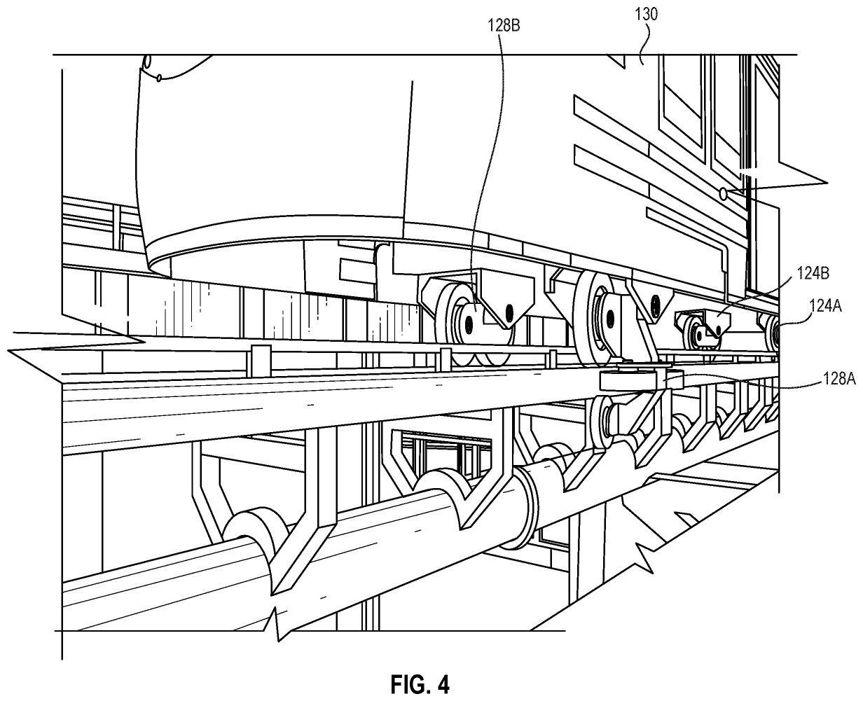

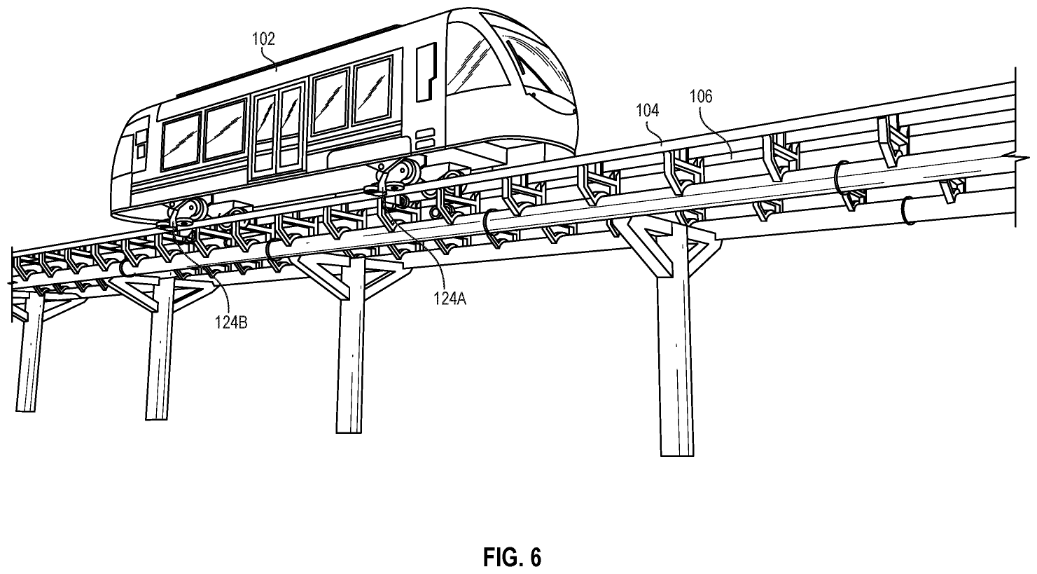

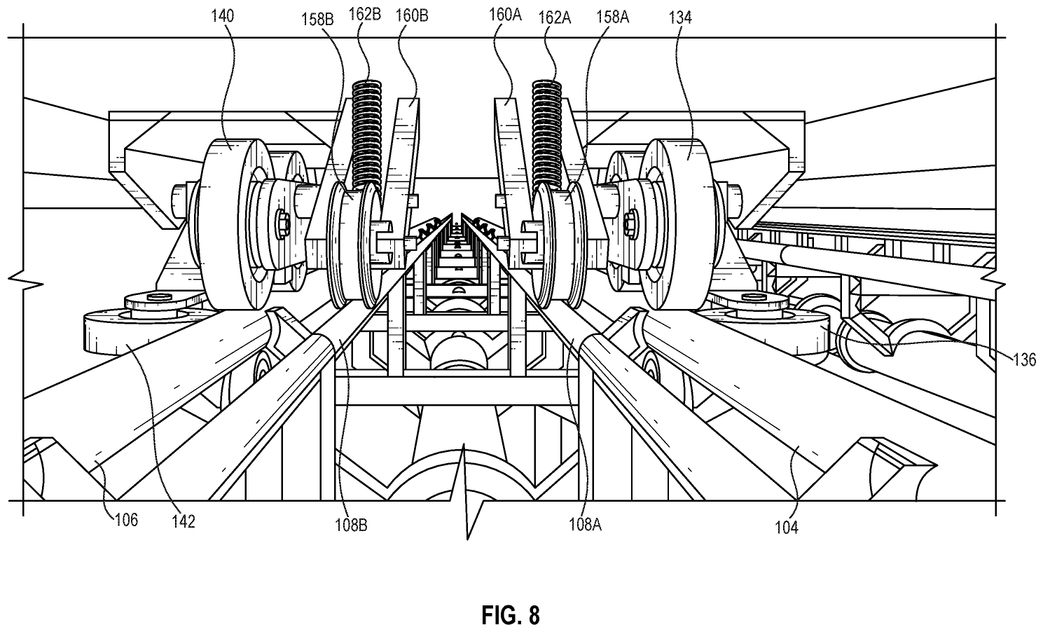

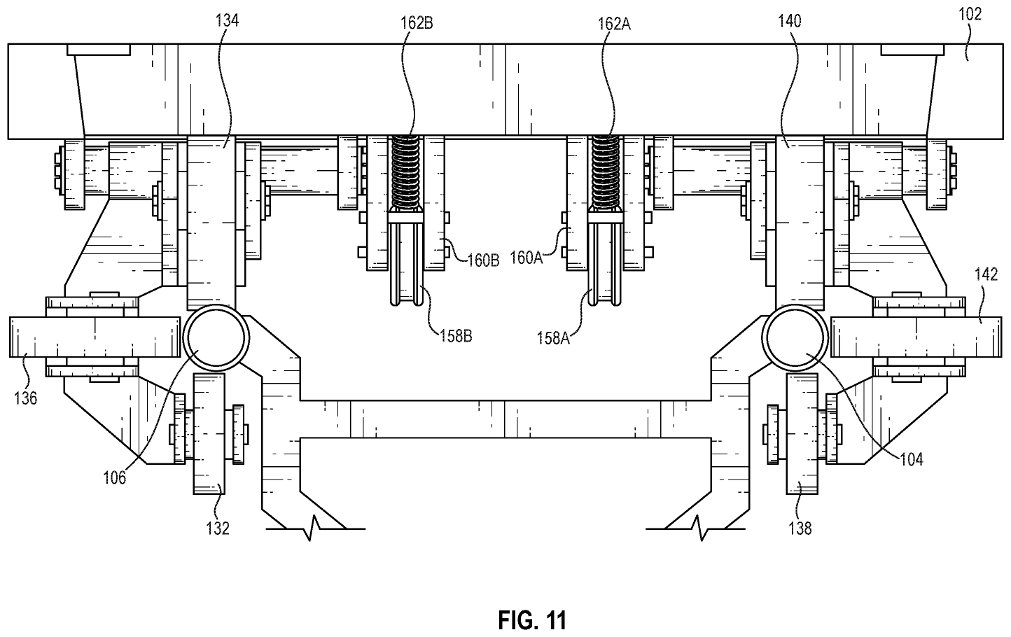

Referring to FIGS. 1-12, in some embodiments, a light rail transit system 100 comprises a railcar 102, a first riding rail 104 and a second riding rail 106, at least one power rail 108, and a plurality of solar panels 110 for providing power to the at least one power rail 108. As shown, the light rail system comprises a first pair of tracks 112 (comprising a first riding rail 104 and second riding rail 106) and a second pair of tracks 114 (likewise comprising a first riding rail 104 and second riding rail 106). Additionally, the plurality of solar panels 110 may be located on the roof 116 of the station 118, on the roof 120 (FIG. 2) of the parking structures 122, or at any other location provided the power generated by the solar panels 110 is easily transmitted to the one or more power rails 108. However, unlike current third rail systems in the art, which always have live current running therethrough for the length of the tracks, the light rail transit system 100 herein does not have a power rail 108 running the length of the tracks, nor is the power rail 108 live with current when not in contact with the railcar 102, as will be discussed in more detail later herein.

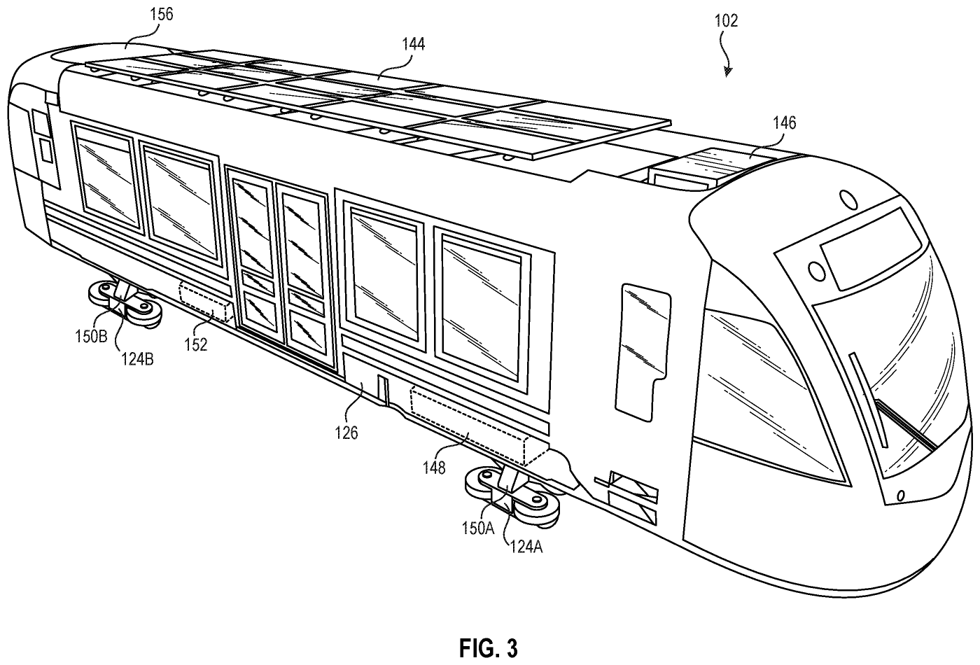

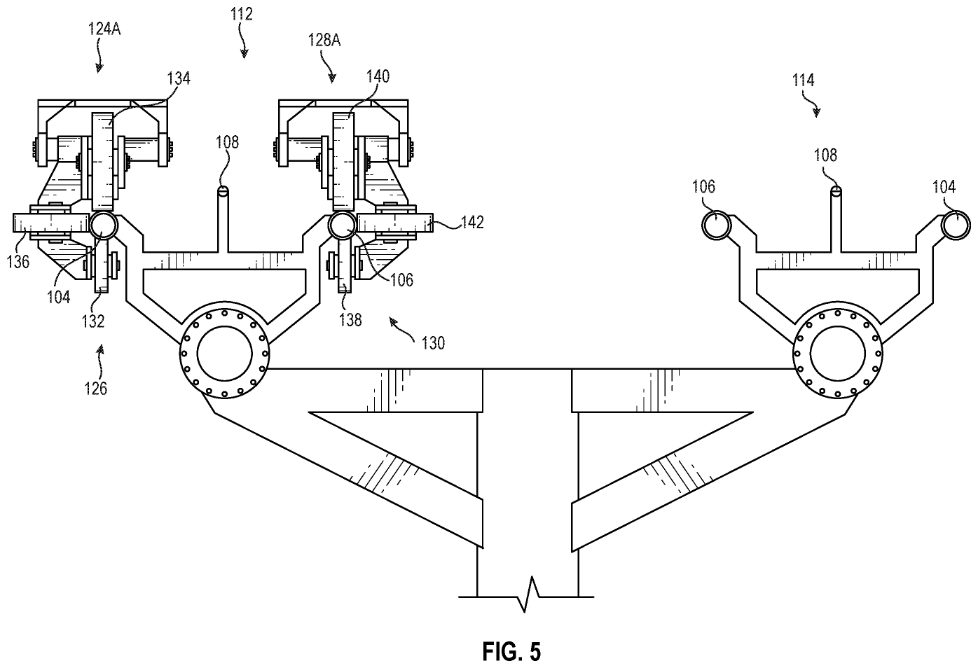

As best seen in FIGS. 3-7, the railcar 102 comprises a plurality of first wheel assemblies 124A-B on a first side 126, and a plurality of second wheel assemblies 128A-B on a second side 130. Each wheel assembly 124A-B, 128A-B is similar to a roller-coaster wheel assembly. In other words, referring to FIG. 5, each first wheel assembly 124A comprises underfriction wheels (aka up-stop wheels) 132, tractor wheels (aka running wheels) 134, and side friction wheels 136. Likewise, each second wheel assembly 128A comprises underfriction wheels 138, tractor wheels 140, and side friction wheels 142. While side friction wheels 136, 142 are shown as being on the outside of the first riding rail 104 and second riding rail 106, respectively, it will be appreciated that the side friction wheels 136, 142 may also be located on the opposite side of the respective rails without departing herefrom (i.e., located inside the pair of tracks). As appreciated, the underfriction wheels 132, 138 and side friction wheels 136, 142 prevent the railcar 102 from derailing.

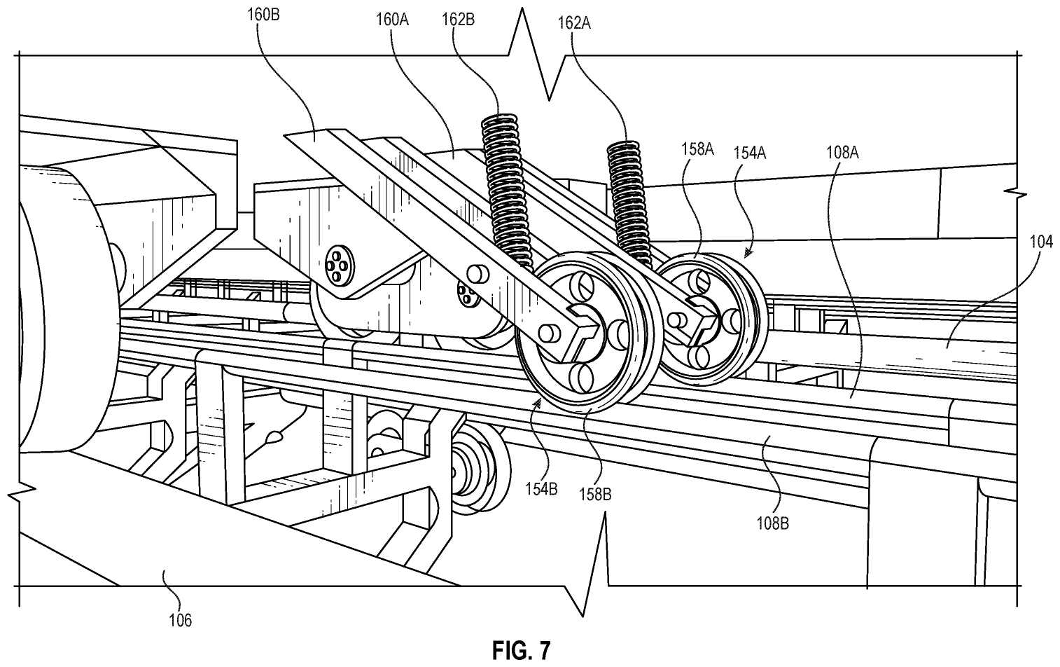

Referring back to FIG. 3, the railcar 102 may further comprise a plurality of solar panels 144 thereon, a solar charge controller 146, a battery bank 148, one or more electric motors 150A-B for driving the respective wheel assemblies 124A-B, an inverter 152, and at least one power rail contactor 154A-B (FIG. 7). As understood from FIG. 3, the plurality of solar panels 144 may be mounted on the roof 156 of the railcar 102 for maximum exposure to the sun. However, it will be appreciated that other configurations, or additional solar panels 144, may be used to generate power. The power generated by the solar panels is then used to charge the battery bank 148 via the solar charge controller 146. The battery bank 148 then supplies power to the electric motors 150A-B (ideally an electric motor coupled to each wheel assembly 124A-B, 128A-B to drive the tractor wheels 134, 140). It will be appreciated that any of the wheels of the wheel assemblies 124A-B, 128A-B may be motor driven without departing herefrom.

When there is sufficient solar power being generated, and the battery bank 148 meets or exceeds a predetermined charge, the solar charge controller 146 may direct power directly to the electric motors 150A-B. In other words, unlike the prior art, which relies on a catenary for the length of the track or requires a third rail with current flowing for the length of the track, the light rail transit system 100 disclosed herein may only use a power rail 108 intermittently and otherwise relies on battery and solar power to move the railcar 102. This is not only more efficient, but safer since there is not live current flowing for the length of the track.

For example, the power rail 108 may be present at the station 118 (for example, running the length of the railcar 102 when parked), allowing the railcar 102 to receive additional power from the solar panels 110. As a result, while the railcar 102 is parked, as shown in FIG. 1, it may be receiving power to ensure that the battery bank 148 meets or exceeds a predetermined threshold. In some embodiments, the power rail 108 may not extend beyond the distance of the station 118, helping to prevent accidental shock by anyone attempting to cross the tracks. In some embodiments, the power rail 108 may only extend a limited distance (e.g., 100 feet) beyond the station 118. As a result, once the railcar 102 leaves the station 118 and the power rail contactor 154A-B leaves contact with the power rail 108, the railcar 102 is powered exclusively by the battery bank 148 and the solar panels 144 on its roof 156. The inverter 152 provides AC power to users within the cabin of the railcar 102 as well. While an inverter 152 is shown, it is not required. For example, the electric motors 150A-B may be DC powered and the power inside the cabin of the railcar 102 may likewise be DC, allowing users to charge phones and other DC power compatible mobile devices.

It will be understood that because the railcar 102 comprises solar panels 144 mounted thereon, the battery bank 148 may continue to be charged despite the lack of a power rail 108 along sections of the track. As appreciated, this allows the light rail transit system 100 to be independent of the power grid (i.e., utility provider) and to be both efficient and environmentally friendly. Nonetheless, to ensure that the railcar 102 has enough power to reach its destination, one or more sections of track (e.g., 1-mile lengths) may comprise a power rail 108 for engaging with the one or more power rail contactors 154A-B, thereby supplying additional current to charge the battery bank 148 over the distance of the power rail 108. In other words, a given light rail route may comprise a plurality of power rails 108, each located along the route and separated from one another sufficiently so as to avoid arcing. For example, the power rail contactors 154A-B may comprise a contact pad or wheel 158A-B for coming into contact with the power rail 108A-B. The contact pad or wheel 158A-B is conductive and transmits the current received from the power rail 108A-B to the battery bank 148 (which may include a battery charge controller or may be combined with the solar charge controller 146), thereby charging the battery bank 148 while the contact pad or wheel 158A-B remains in contact with the power rail 108A-B. The power rail contactors 154A-B would then make contact with each of the power rails along the route in sequence. As shown, two power rails 108A, 108B may be parallel to one another to provide additional current to the railcar 102. The two power rails 108A, 108B extend for the same length, upon which there is a gap with no power rails 108A, 108B, until a second set of power rails may be engaged along the track.

FIGS. 7-12 illustrate how the power rail contactors 154A-B come into and out of contact with one or more power rails 108A-B. For example, the power rail contactors 154A-B comprise a pad or wheel 158A-B on a distal end of a hinged arm 160A-B. To ensure that the hinged arms 160A-B remain extended so that the pad or wheels 158A-B remain in contact with the power rails 108A-B, respectively, a spring 162A-B may be positioned to exert a downward force on the hinged arms 160A-B. The springs 162A-B are compressed when the wheels 158A-B engage with the power rails 108A-B, respectively. Because the wheels 158A-B are conductive, they are capable of receiving and transmitting power (e.g., current) from the power rails 108A-B to the battery bank 148 (via a charge controller).

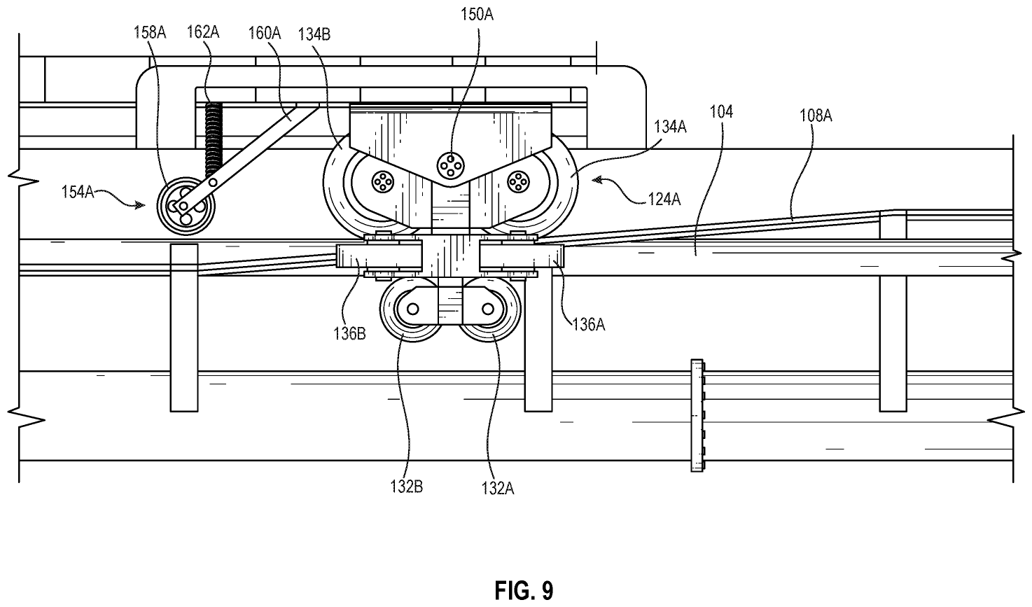

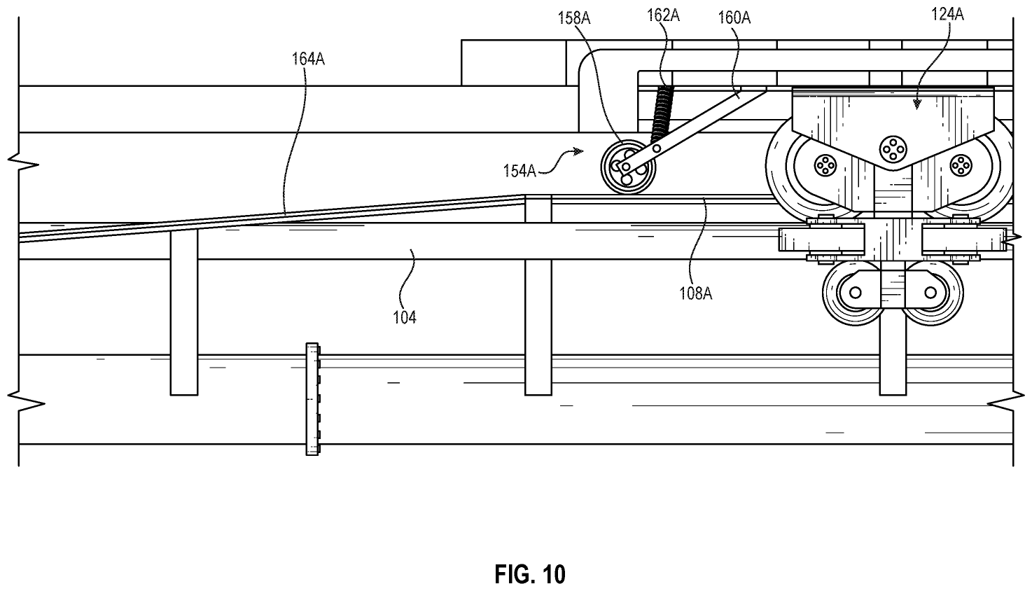

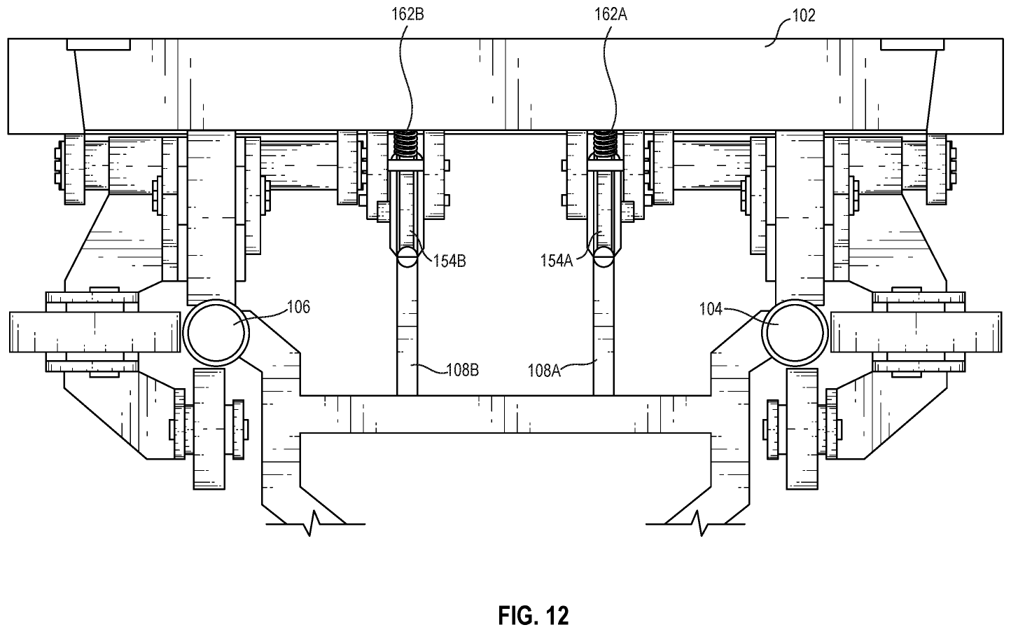

FIGS. 9 & 11 illustrate the power rail contactors 154A-B in a first, extended position wherein the wheels 158A-B are not in contact with the power rails 108A-B. In this first position, the railcar 102 is using solar power from the solar panels 144 and power from the battery bank 148 to drive the electric motors 150A-B. As a result, the railcar 102 is not dependent on power from other sources, and is likewise not affected by grid power outages. FIGS. 10 and 12 illustrate the power rail contactors 154A-B in a second, compressed position wherein the wheels 158A-B are in contact with the power rails 108A-B, allowing power to be conducted therebetween. For example, in some embodiments, the power rails 108A-B may have a first, sloped section 164A-B allowing the pad or wheels 158A-B to engage and gradually compress the springs 162A-B. The springs 162A-B ensure that the wheels 158A-B remain in contact with the power rails 108A-B, respectively, for the length of the power rails 158A-B, thereby ensuring maximum power transfer from the power rails 108A-B to the railcar 102.

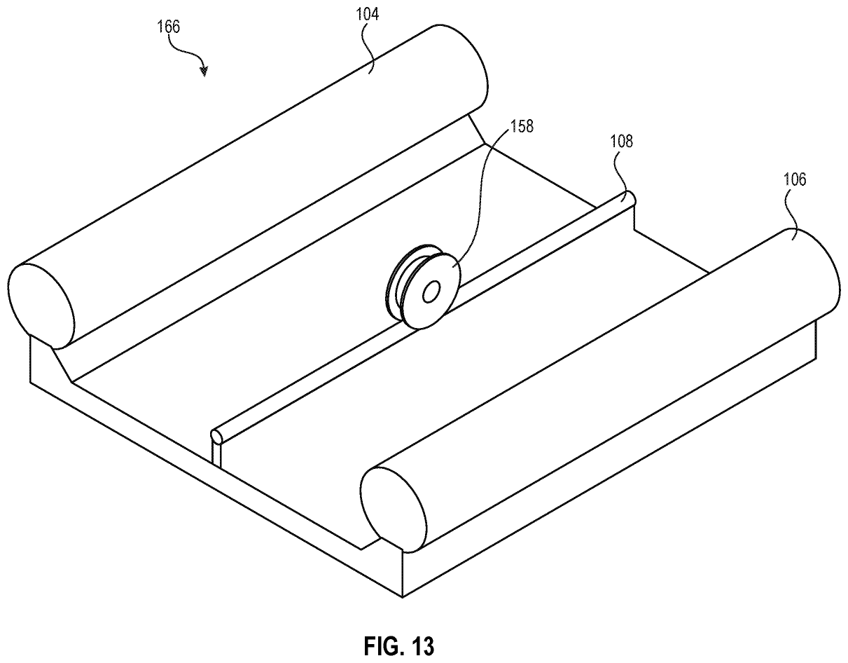

FIGS. 13-18 illustrate various examples of power rail contactors and power rails. For example, FIG. 13 illustrates a track segment 166 comprising first riding rail 104, a second riding rail 106, a power rail 108, and a wheel 158 of a power rail contactor 154 (the remaining components of the power rail contactor and the railcar 102 not shown). The power rail 108 provides current to the railcar 102 via the wheel 158. In some embodiments, the power rail 108 has current that passes through it constantly. However, in the preferred embodiments, the power rails 108 only receive current when it is determined that the power rail contactors 154A-B are in contact with the power rails 108A-B. In other words, to be effective, the power rails 108 do not extend the length of the track (e.g., rails 104 and 106), but are segmented along the length to interrupt the flow of current.

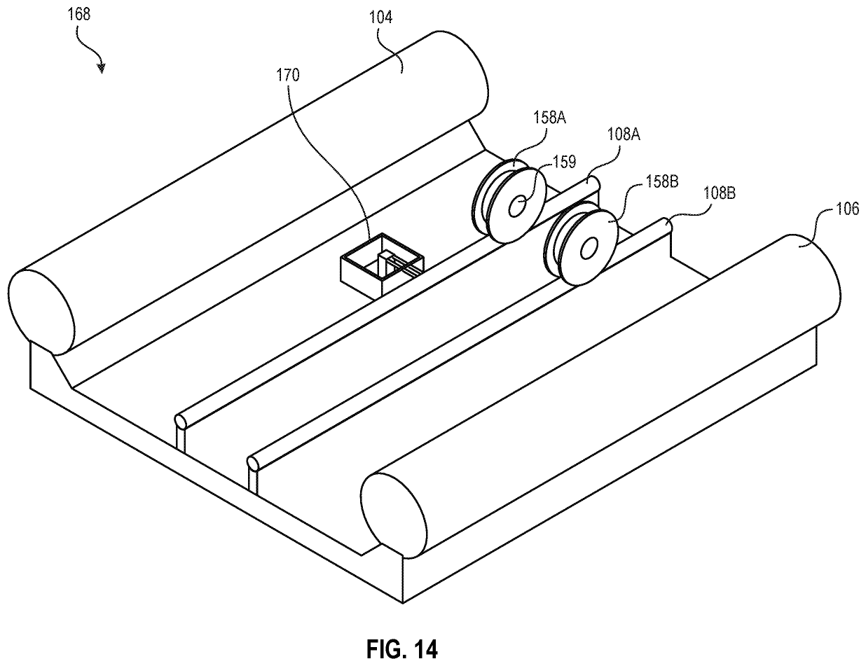

For example, in FIG. 14, a track segment 168 comprises a first riding rail 104, a second riding rail 106, a first power rail 108A, a second power rail 108B, and a controller 170 (e.g., microcontroller). In some embodiments, the controller 170 comprises a sensor and is configured to electrically couple and de-couple power to the power rails 108A, 108B. When the controller 170 detects that the wheels 158A-B are in contact with the respective rails 108A, 108B, such as by detecting a closed circuit between the first power rail 108A and second power rail 108B via the wheels 158A-B, the controller 170 may close a circuit allowing the full voltage (e.g., 400+ Volts) to pass to the first and second power rails 108A-B.

Rather than detecting a closed circuit, the controller 170 may detect when the wheels 158A-B are in contact with the power rails 108A-B using signals transmitted to the railcar 102 via the wheels 158A-B, which are returned by a controller of the railcar 102. Upon receiving the returned signal, the controller 170 transmits power to the power rails 108A-B. In some embodiments, the controller 170 comprises a wireless transceiver for detecting when the wheels 158A-B have come into contact with the power rails 108A-B, such as by the wheels 158A-B or other component of the railcar 102 comprising a wireless chip 159 (e.g., an RFID chip, NFC chip, or wireless transceiver (e.g., Bluetooth®)) for communicating with the wireless transceiver of the controller 170. In such a scenario, a first controller 170 is configured to detect when the railcar 102 makes contact with the power rails 108A-B and a second controller (not shown) may detect (using the same or similar technologies as the first controller 170) when the railcar 102 exits the section of track comprising the power rails 108A-B, which then opens a circuit to prevent power from transmitting on the power rails 108A-B that have lost contact with the wheels 158A-B. As a result, even if a user were to touch both power rails 108A-B simultaneously, they would not be shocked or electrocuted.

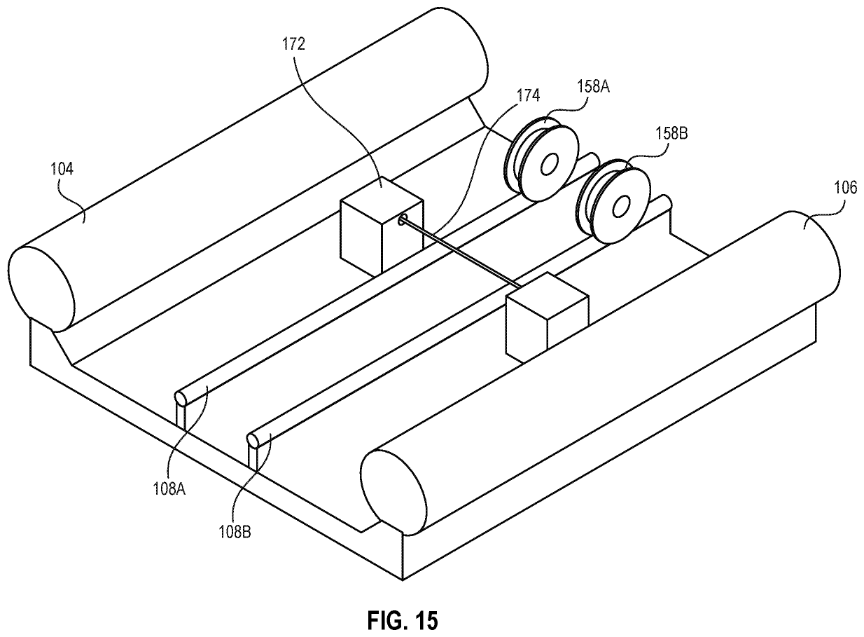

Referring to FIG. 15, in some embodiments, a controller 172 may comprise an infrared sensor and may transmit an infrared beam 174 across a first power rail 108A and second power rail 108B. When the wheels 158A-B interrupt the infrared beam 174, the controller 172 closes a circuit so that power transmits to the power rails 108A-B from one or more solar panels 110 of the station 118 or other location, or may also receive power from the grid (utility provider). When receiving power from the grid, it will be appreciated that it will normally be AC power. Accordingly, the railcar 102 may comprise a converter for converting the AC to DC as needed. In some embodiments, the power generated by the solar panels 110 may be transmitted to the grid (utility provider) when not in use for charging the battery bank 148 of a railcar 102. It will be appreciated that a second controller 172, placed at or near the end of the power rails 108A-B, may be used to determine when the railcar 102 exits the power rails 108A-B and the controller 172 may thereby cut power (e.g., open a circuit) to the power rails 108A-B. It will be appreciated that cutting power to the power rails 108A-B when not in use by a railcar 102 increases safety by preventing accidental electrocution by people or animals that may attempt to cross the power rails 108A-B. This is a significant, life-saving improvement over the prior art.

In some embodiments, the power rails 108A-B may extend substantially the entire length (e.g., three-fourths or more) between a first station and a second station. In such a scenario, the power rails 108A-B may still be segmented and separated by enough distance from one another to prevent arcing. In this manner, a railcar 102 could receive power from other sources (i.e., sources external to the railcar 102, such as solar panels 110, other clean energy sources, or grid power) for substantially the entire route while still ensuring that only the current section of track where the railcar 102 is located has current passing through the power rails 108A-B. In some embodiments, the power rails 108A-B are segmented and extend less than the distance of the track (i.e., less than the distance of the first riding rail 104 and second riding rail 106). As discussed earlier, when the railcar 102 is on a section of track comprising only a first riding rail 104 and second riding rail 106 (i.e., no power rail 108), the railcar 102 uses the battery bank 148 to actuate the motors 150A-B and to provide power to the cabin of the railcar 102 and to operate other components, such as heating and air conditioning.

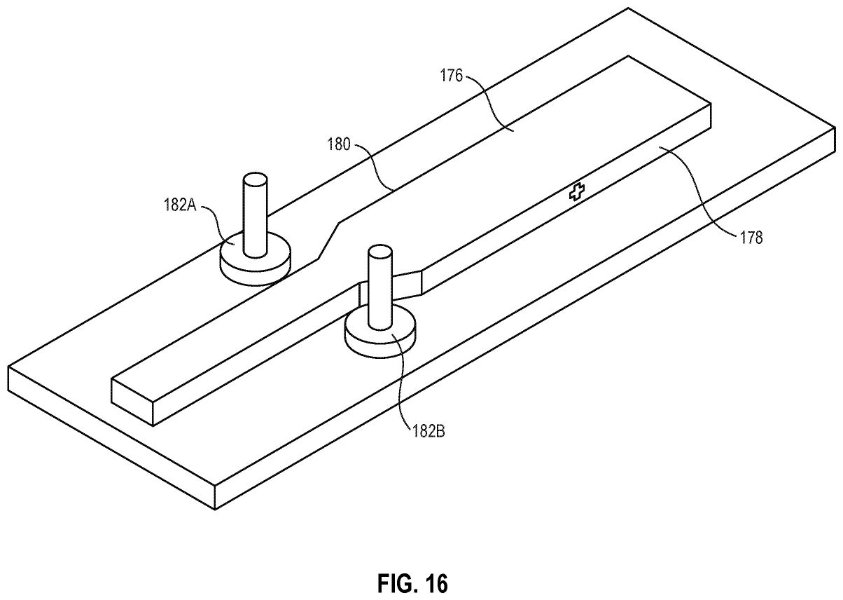

While the power rail contactors 154A-B have been described and shown with wheels 158A-B that extend downwardly to connect with a power rail 108A-B, such a configuration is not required. For example, FIG. 16 illustrates a power rail 176 comprising a positive side 178 and a negative side 180. The power rail contactors 154A-B comprise wheels 182A-B that, when in contact with the negative and positive sides 178, 180, respectively, power is transmitted from the power rail 176 to the railcar 102. The form factor and configuration of the positive and negative sides 178, 180 reduce the risk of electrocution by a user who only inadvertently comes into contact with one of the sides.

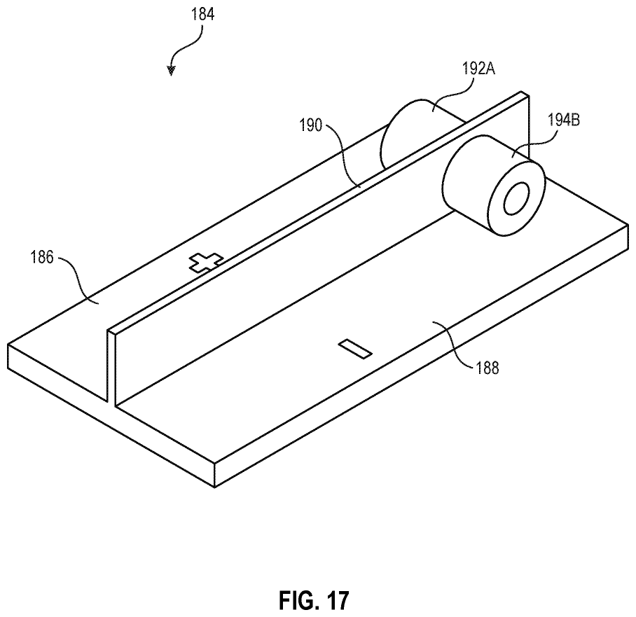

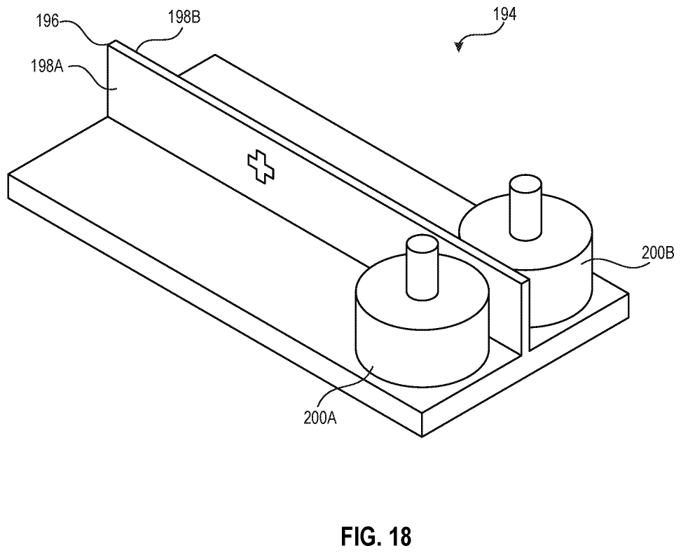

FIG. 17 illustrates a power rail 184 having a positive side 186 and a negative side 188, separated by an insulator panel 190. The wheels 192A-B conduct power to the railcar 102 when in contact with the power rail 184. Again, the configuration reduces the odds of electrocution by requiring contact on both the positive and negative sides 186, 188 simultaneously. The insulator panel 190 prevents arcing between the two sides. FIG. 18 illustrates a power rail 194 comprising a separator panel 196 comprising a positive side 198A and a negative side 198B. The wheels 200A-B conduct power to the railcar 102 when in contact with the positive side and negative side 198A-B, respectively. Again, this reduces the risk of electrocution by requiring two contact points.

In some embodiments, the power contactors 154A-B comprise an extension bar that is electronically controlled to pivot from a first, non-contact position, to a second, contact position for receiving power from the power rails 108. For example, when the battery bank 148 has sufficient charge, as determined by one or more processors of the solar charge controller 146, the power contactors 154A-B remain in a first, non-contact position. However, if the batteries fall below a predetermined threshold, the solar charge controller 146 signals the power contactors 154A-B to lower and contact the power rails 108 to provide power to charge the battery bank 148. It will be appreciated that the railcar 102 may comprise one or both of an inverter and converter so that appropriate power is received and/or provided to various components. Once the battery bank 148 reaches a predetermined charge threshold, the power contactors 154A-B may disconnect by retracting. As disclosed earlier, the power rail 108 may remain without current until the one or more power contactors 154A-B contact the power rail 108.

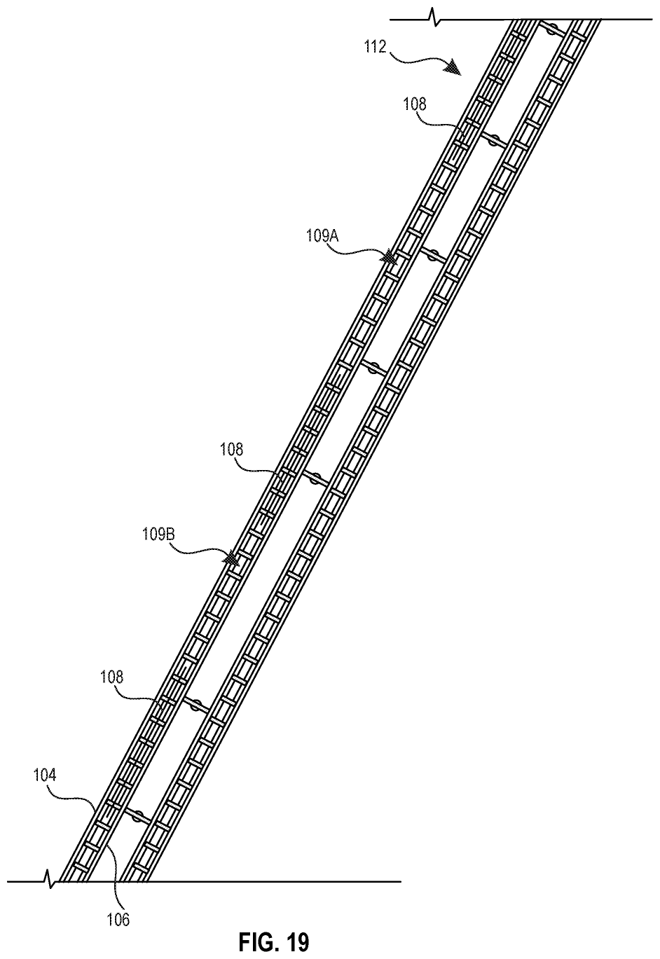

Referring to FIG. 19, a first pair of tracks 112 are illustrated with a plurality of power rails 108 extending along the length of the pair of tracks 112. As shown, the power rails 108 are separated from one another to avoid arcing via first gap 109A and second gap 109B. As described earlier herein, each power rail 108 transmits current only when in contact with a railcar 102. In some embodiments, the first and second gaps 109A, 109B are long enough to prevent a railcar 102 from coming into contact with more than one power rail 108 at a time.

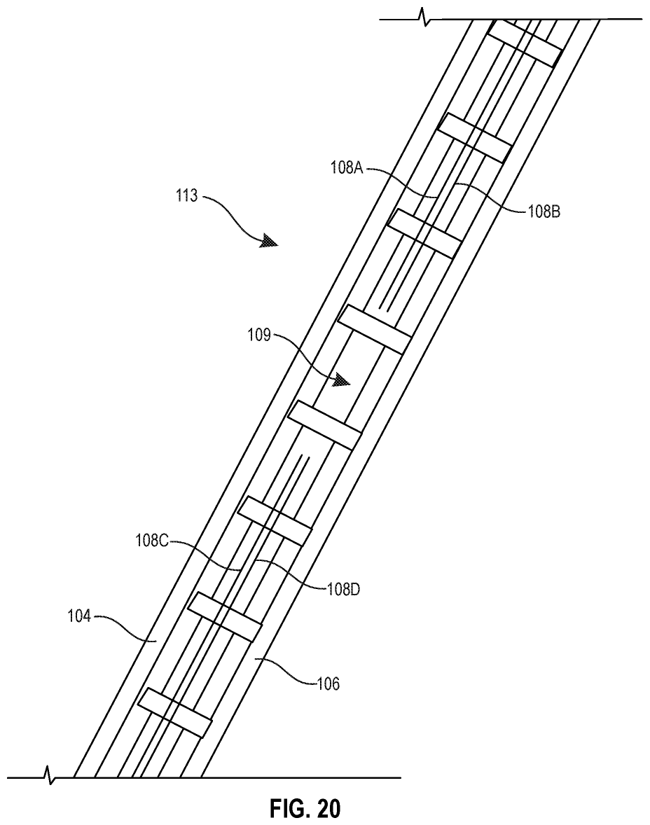

Referring to FIG. 20, a first pair of tracks 113 comprise a first power rail 108A and a second power rail 108B extending parallel to one another and interposed between the first riding rail 104 and second riding rail 106. A third power rail 108C and fourth power rail 108D are separated by a gap 109 from the first and second power rails 108A-B. In some embodiments, the gap 109 is of sufficient length to prohibit a railcar 102 from contacting all four rails 108A-D simultaneously. However, in other embodiments, the gap 109 may be short enough to allow the railcar 102 to contact all four rails 108A-D simultaneously, although for a brief period as the railcar 102 move along the tracks so as to thereby prevent current flowing through all power rails 108-D for an extended length. In a preferred embodiment, the gap 109 is longer than the railcar 102, such that the railcar 102 is not in contact with any power rails 108A-D for a period of time as it travels and relies, instead, on the battery bank 148 for power to drive the railcar 102 forward.

As appreciated from the foregoing, a majority, if not all, of the power consumed by the railcar 102 is derived from solar energy. By not using overhead lines, the light rail transit system 100 is also more aesthetically pleasing. Further, due to the use of at least one power rail 108 that extends for less than the length of the track (i.e., less than the length of the first and second rails 104, 106), the risk of electrocution is reduced or eliminated. Therefore, the light rail transit system 100 solves the need for a rail system that utilizes renewable energy, that is not susceptible to grid power loss, that is not unsightly, and that reduces or eliminates risk of electrocution.

It will be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A light rail transit system, comprising:
a station comprising a plurality of solar panels;
a first riding rail and a second riding rail each having a first length;
a power rail having a second length that is shorter than the first length; and
a railcar, comprising:
a plurality of first wheel assemblies configured to drive along the first riding rail,
a plurality of second wheel assemblies configured to drive along the second riding rail,
at least one power rail contactor,
a plurality of solar panels,
a solar charge controller,
a battery bank, and
a plurality of electric motors configured to drive at least one wheel of each of the plurality of first and second wheel assemblies.

2. The light rail transit system of claim 1, wherein each wheel assembly of the first and second wheel assemblies comprises an underfriction wheel, a side friction wheel, and a tractor wheel.

3. The light rail transit system of claim 1, wherein the plurality of solar panels of the station are configured to provide power to the power rail.

4. The light rail transit system of claim 3, further comprising a controller configured to control the power status of the power rail.

5. The light rail transit system of claim 4, further comprising a first sensor configured to detect when the at least one power contactor is in contact with the power rail.

6. The light rail transit system of claim 5, wherein the first sensor is an infrared sensor.

7. The light rail transit system of claim 5, further comprising a second sensor configured to detect when the at least one power contactor is not in contact with the power rail.

8. The light rail transit system of claim 1, wherein the at least one power contactor comprises a hinged arm, a spring configured to extend the hinged arm in a first direction, and a wheel at a distal end of the hinged arm, the wheel configured to ride on the power rail.

9. A light rail transit system, comprising:
a station comprising a plurality of solar panels;
a first riding rail and a second riding rail each having a first length;
a plurality of power rails, each having a second length that is shorter than the first length, each power rail interposed between the first riding rail and the second riding rail; and
a railcar, comprising:
a plurality of first wheel assemblies configured to drive along the first riding rail, each first wheel assembly comprising at least one underfriction wheel, at least one side friction wheel, and at least one tractor wheel, a plurality of second wheel assemblies configured to drive along the second riding rail, each second wheel assembly comprising at least one underfriction wheel, at least one side friction wheel, and at least one tractor wheel,
at least one power rail contactor configured to contact each of the plurality of power rails,
a battery bank
plurality of solar panels,
a solar charge controller configured to charge the battery bank, and
a plurality of electric motors receiving power from the battery bank and each configured to drive at least one wheel of each of the plurality of first and second wheel assemblies;
wherein each power rail of the plurality of power rails is configured to only transmit power when the at least one power rail contactor is in contact with a respective power rail of the plurality of power rails.

10. The light rail transit system of claim 9, wherein the plurality of solar panels of the station are configured to provide power to the plurality of power rails.

11. The light rail transit system of claim 10, further comprising at least one controller configured to control the power status of the plurality of power rails.

12. The light rail transit system of claim 10, further comprising a first sensor configured to detect when the at least one power contactor is in contact with one of the power rails of the plurality of power rails.

13. The light rail transit system of claim 12, wherein the sensor is an infrared sensor.

14. The light rail transit system of claim 12, further comprising a second sensor configured to detect when the at least one power contactor is not in contact with the plurality of power rails.

15. The light rail transit system of claim 9, wherein the at least one power contactor comprises a hinged arm, a spring configured to extend the hinged arm in a first direction, and a wheel at a distal end of the hinged arm, the wheel configured to ride on each power rail of the plurality of power wheels, respectively.

16. A light rail transit system, comprising:
a first riding rail;
a second riding rail;
a plurality of power rails interposed between the first and second riding rails, each power rail extending longitudinally in relation to one another and at a first distance from one another; and,
a plurality of solar panels configured to provide power to each of the plurality of power rails;
wherein each power rail is configured to only conduct power in response to detecting that a power contactor of a railcar is in contact with the respective power rail.

17. The light rail transit system of claim 16, further comprising a first sensor configured to detect when the at least one power contactor is in contact with the respective power rail.

18. The light rail transit system of claim 17, wherein the first sensor is an infrared sensor.

19. The light rail transit system of claim 17, further comprising a second sensor configured to detect when the at least one power contactor is not in contact with the respective power rail.

20. The light rail transit system of claim 17, wherein the railcar further comprises a battery bank, the battery bank configured to receive power through solar panels coupled to the railcar, the power contactor, or a combination thereof.
